(19) United States
(12) Patent Application Publication
(10) Pub. No.: US 2015/0298656 A1
(43) Pub. Date: Oct. 22, 2015

(54) ACOUSTICAL AND RAIN CLEARING WINDOW ASSEMBLY FOR A VEHICLE

(71) Applicant: Magna International Inc., Aurora (CA)

(72) Inventor: David Mark Pascoe, Aurora (CA)

(21) Appl. No.: 14/686,017

(22) Filed: Apr. 14, 2015

Related U.S. Application Data
(60) Provisional application No. 61/982,583, filed on Apr. 22, 2014.

(51) Int. Cl. B60S 1/02; B60J 1/02; H04R 1/02; B60J 1/08; B60J 7/043; B60J 1/00; B60J 1/18

(52) U.S. Cl. CPC B60S 1/02; B60J 1/00; B60J 1/006; B60J 1/02; B60J 1/18; B60J 1/08; B60J 7/043; H04R 1/028; H04R 2499/13

(57) ABSTRACT

An acoustical and rain clearing window assembly for a vehicle includes a window panel mounted to the vehicle and at least one exciter attached to the window panel. An exciter control unit is connected to the at least one exciter and is configured to generate a superposition wave form for communication to the at least one exciter to simultaneously produce audio sound within the vehicle and clear water from the window panel. The exciter control unit is electrically connected to a first mode switch for receiving a first input signal to initiate the production of audio sound within the vehicle and a second mode switch for receiving a second input signal to initiate the clearing of water from the window panel. The exciter control unit is configured to receive the first and second input signals and combine the first and second input signals into the superposition wave form.

### CROSS REFERENCE TO RELATED APPLICATION

The present application claims priority to U.S. patent application Ser. No. 61/982,583 filed on Apr. 22, 2014, the entire disclosure of which is incorporated herein by reference.

### FIELD OF THE INVENTION

The present disclosure relates generally to a window assembly for a vehicle and, more particularly, a window assembly that includes a window panel that may be installed in a vehicle as a unit or as separate components.

### BACKGROUND OF THE INVENTION

This section provides a general summary of background information and the comments and examples provided in this section are not necessarily prior art to the present disclosure.

Sound systems for vehicles have become increasingly complicated and sophisticated as vehicle owners desire enhanced sound quality in their vehicles, However, vehicle manufacturers often encounter packaging difficulties when attempting to fit large speakers, such as sub-woofers or the like, within the vehicle to provide the desired enhanced sound quality. Thus, it has been previously proposed to provide an audio speaker for a vehicle sound system by vibrating a panel of the vehicle, such as a window or trim panel or the like. One such audio device is disclosed in U.S. Pat. No. 8,457,325 directed to an “Acoustical Window Assembly for Vehicle”. However, such prior art window assemblies only produce audio through the vibration of the panel of the vehicle.

Other window assemblies have been proposed to remove water, such as rain drops, from a surface of a panel, such as a windshield, mirror, or lens surface, by shaking water off the surface of the panel. In such window assemblies, the panel is oscillated to decrease the surface adhesion of the water, causing the water to be shaken off the surface of the panel. One such window assembly is disclosed in U.S. Pat. No. 4,833,373 directed to a “System for Shaking Water Off Windshield”. However, these prior art window assemblies only clear or shake water off the panel of the vehicle.

Although the prior art window assemblies are able to either provide an audio speaker for a cabin of a vehicle or clear water off a panel of the vehicle, none of the prior art window assemblies are able to accomplish each of these functions simultaneously. Put another way, the prior art window assemblies are not capable of producing a wave form which simultaneously produces both a sound for a cabin of the vehicle and clears water from a panel of the vehicle.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a vehicle incorporating an acoustical and rain clearing window assembly;

FIG. 2 is a perspective view of the acoustical and rain clearing window assembly illustrating an exciter control unit electrically connected to at least one exciter, at least one mode switch, and a vehicle power;

FIG. 3 is a cross-sectional view illustrating a panel of the acoustical and rain clearing window assembly attached to the vehicle using a seal; and

FIG. 4 is an illustrative superposition wave produced by the exciter control unit for controlling the at least one exciter.

### DETAILED DESCRIPTION OF THE ENABLING EMBODIMENTS

Example embodiments of an acoustical and rain clearing window assembly constructed in accordance with the present disclosure will now be more fully described. Each of these example embodiments are provided so that this disclosure is thorough and fully conveys the scope of the inventive concepts, features and advantages to those skilled in the art. To this end, numerous specific details are set forth such as examples of specific components, devices and mechanisms associated with the acoustical and rain clearing window assembly to provide a thorough understanding of each of the embodiments associated with the present disclosure. However, as will be apparent to those skilled in the art, not all specific details described herein need to be employed, the example embodiments may be embodied in many different forms, and thus should not be construed or interpreted to limit the scope of the disclosure.

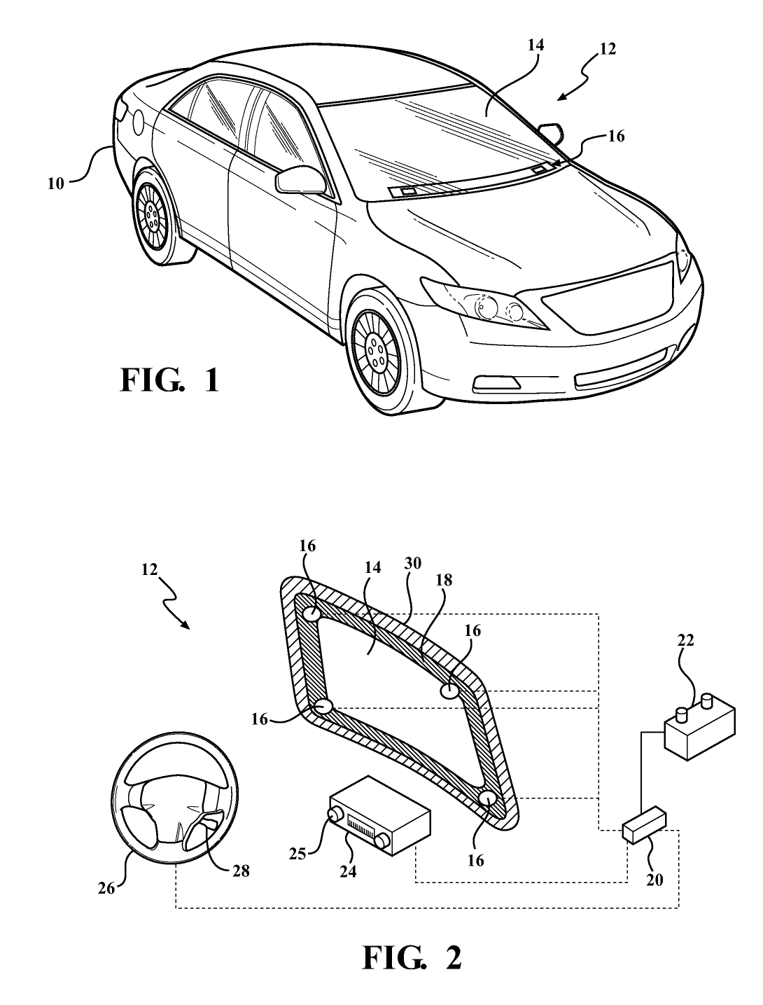

FIG. 1 is a perspective view of a vehicle 10 and generally shows an acoustical and rain clearing window assembly 12 incorporated therein. The acoustical and rain clearing window assembly 12 preferably includes a transparent glass window panel 14, such as a windshield of the vehicle. However the window panel 14 may also comprise any other window of the vehicle, such as, for example, a rear window or backlite, a side window, a side door window, a moon roof, or a sunroof of the vehicle 10. It is also envisioned that aspects of the present invention may be suited for application to movable window panels as well, such as a lift gate window. As will be described in more detail below, the window panel 14 is mounted or attached to the vehicle 10 in a variety of ways, such as by adhesive, fasteners or the like, and is substantially sealed to the vehicle 10 around its perimeter edge regions to limit leakage at the window panel 14.

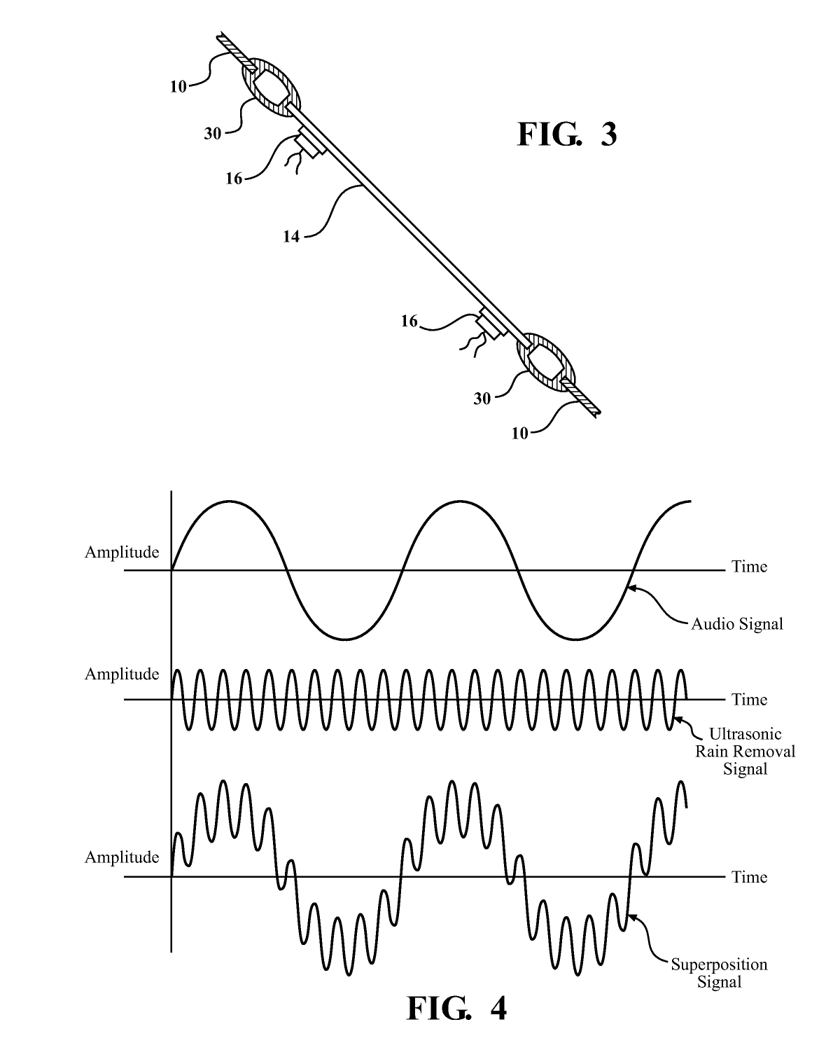

As shown in FIG. 1, the acoustical and rain clearing window assembly 12 includes at least one exciter 16 preferably positioned at or near a perimeter edge or region of the window panel 14, such as generally at or near the bottom or lower perimeter portion of window panel 14. However, as best shown in FIGS. 2 and 3, in an aspect the at least one exciter 16 can include a plurality of exciters 16 disposed in spaced relationship to one another around the perimeter of the window panel 16. In either aspect, the arrangement of the at least one exciter 16 along the perimeter of the window panel 16 avoids interference with the ability of a driver to view through the transparent or substantially transparent window panel 14. The at least one exciter 16 is thus disposed at and substantially hidden along the perimeter region of the window panel 14. As best shown in FIG. 2, a windshield masking 18 can additionally be disposed adjacent or along the perimeter region of the window panel 14 to further hide the at least one exciter 16 from a driver's view.

As best shown in FIG. 2, the at least one exciter 16 of the acoustic and rain clearing window assembly 12 is in electrical communication with an exciter control unit 20 which is powered by the vehicle's power supply 22. As needed, the acoustical and rain clearing window assembly may utilize aspects of the exciter and exciter control unit described in U.S. Pat. No. 8,457,323, which is commonly owned by applicant and the entire extent of which is hereby incorporated by reference. The exciter control unit 20 is in electrical communication with both a vehicle information and entertainment system 24 and a steering wheel 26 of the vehicle 10. The vehicle information and entertainment system 24 includes a first mode switch 25 for sending a first input signal, such as an audio wave illustratively shown in FIG. 4, for producing audio sound by the window panel 14. The steering wheel 26 includes a second mode switch 28 for sending a second input signal, such as an ultrasonic wave form illustratively shown in FIG. 4, for clearing rain water from the window panel 14. In alternative embodiments, the second mode switch 28 can be disposed on a dash of the vehicle 10 or electrically connected to a vehicle operator controller for automatic operation of the rain clearing function without driver intervention. The exciter control unit 20 receives the first and second input signals from both the first and second mode switches 26, 28 and proceeds to combine the audio wave form and the ultrasonic wave form into a superposition wave, such as the superposition wave illustratively shown in FIG. 4. The superposition wave form is then sent by the exciter control unit 20 to the at least one exciter 16 to effectuate both the audio and rain cleaning functions of the window assembly 12 simultaneously. Put another way, a single output from the exciter control unit 20, in the form of a superposition wave form, is able to drive or excite the window panel 14 by way of the at least one exciter 16 to simultaneously produce sound within the vehicle and clear rain from the window panel 14. The use of a superposition wave form by the exciter control unit 20 facilitates both the acoustic and water clearing functions through the use of a single, common exciter control unit 20. As a result, the subject acoustic and rain clearing window assembly 12 leads to a reduction in parts, and thus reduced manufacturing costs, over prior art window assemblies.

Acoustic or sound wave forms are typically a lower frequency than a frequency used by of an ultrasonic wave form to effectively clear rain from a window panel. For example, a window panel may be vibrated at a frequency that crosses at least the entire hearing range of the human ear, e.g., between about 20 Hz and about 20,000 Hz or thereabouts, when the at least one exciter is operated to generate the desired range of sounds. However, the superposition wave form output by the exciter control unit 20 and received by the at least one exciter 16 includes an appropriate frequency operable to excite the windshield and support window clearing, as well as a set of frequencies operable to support music, entertainment or audio information. Without the use of the superposition wave form or the superposition set of output waves by the exciter control unit 20, the acoustical and rain clearing window assembly 12 could not be configured to control both the audio and rain clearing functions simultaneously with a single output signal.

As best shown in FIG. 3, the window panel 14 is preferably mounted to the vehicle using a seal 30 that extends along a mounting or perimeter portion of the window panel 14 to substantially seal the window panel 14 to the vehicle 10. The seal 30 also functions to allow movement or vibration of the window panel 14 by the at least one exciter 16 in response to an output of the superposition wave from the exciter control unit 20. The seal 30 can comprise a suitable adhesive or bonding material, such as a one component urethane adhesive, to provide sufficient flexibility of the window panel 14 relative to the vehicle 10 and allow for the vibrating amplitude to both produce sound and clear water from the window panel surface. In an aspect, the seal 30 may result in one side or perimeter region of the window panel 14 being substantially fixed by the seal 30 and the opposite side or opposite perimeter region of the window panel 14 being flexible to allow the flexible portion of window panel 14 to vibrate or move during actuation of the at least one exciter 16. Put another way, the seal 30 allows for the window panel 14 to move in or out relative to the vehicle 10.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An acoustical and rain clearing window assembly for a vehicle comprising:
a window panel mounted to the vehicle;
at least one exciter attached to the window panel; and
an exciter control unit electrically connected to the at least one exciter and configured to generate a superposition wave form for communication to the at least one exciter to simultaneously produce audio sound within the vehicle and clear water from the window panel.

2. The window assembly as set forth in claim 1, wherein the exciter control unit is electrically connected to at least one mode switch for receiving an input from a driver of the vehicle to initiate the production of audio sound or the clearing of water from the window panel.

3. The window assembly as set forth in claim 2, wherein the at least one mode switch includes a first mode switch for sending a first input signal to the exciter control unit to initiate the production of audio sound and a second mode switch for sending a second input signal to the exciter control unit to initiate the clearing of water from the window panel.

4. The window assembly as set forth in claim 3, wherein the first input signal is an audio wave and the second input signal is an ultrasonic wave, and the exciter control unit is configured to receive the first and second input signals and combine the audio wave and the ultrasonic wave into the superposition wave form.

5. The window assembly as set forth in claim 2, wherein the exciter control unit is electrically connected to a vehicle information and entertainment system, and wherein the first mode switch includes a first mode switch disposed on the vehicle information and entertainment system.

6. The window assembly as set forth in claim 2, wherein the exciter control unit is electrically connected to a steering wheel including the second mode switch.

7. The window assembly as set forth in claim 1, further comprising a seal that extends along a perimeter portion of the window panel for mounting the window panel to the vehicle.

8. The window assembly as set forth in claim 7, wherein the seal is comprised of a flexible adhesive material to allow vibration or movement of the window panel relative to the vehicle during actuation of the at least one exciter.

9. The window assembly as set forth in claim 1, wherein the at least one exciter is disposed adjacent a perimeter region of the window panel to avoid interference with the ability of a driver of the vehicle to view through the window panel.

10. The window assembly as set forth in claim 9, wherein the at least one exciter is disposed along a lower perimeter region of the window panel.

11. The window assembly as set forth in claim 9, wherein the at least one exciter includes a plurality of exciters disposed in spaced relationship to one another and each adjacent the perimeter region of the window panel.

12. The window panel as set forth in claim 9, further comprising a windshield masking disposed adjacent the perimeter region of the window panel to hide the at least one exciter from the driver's view.

13. The window assembly as set forth in claim 1, wherein the exciter control unit is electrically connected to a power supply of the vehicle.

14. The window panel as set forth in claim 1, wherein the window panel includes a windshield of the vehicle.

15. The window panel as set forth in claim 1, wherein the window panel includes at least one of a rear window, a side window, a moon roof, or a sunroof of the vehicle.

16. A vehicle comprising:
a window panel mounted to the vehicle;
at least one exciter attached to the window panel; and
an exciter control unit electrically connected to the at least one exciter and configured to generate a superposition wave form for communication to the at least one exciter to simultaneously produce audio sound within the vehicle and clear water from the window panel.

17. The vehicle as set forth in claim 16, wherein the exciter control unit is electrically connected to at least one mode switch for receiving an input signal from a driver of the vehicle to initiate the production of audio sound or the clearing of water from the window panel.

18. The vehicle as set forth in claim 17, wherein the at least one mode switch includes a first mode switch for sending a first input signal to the exciter control unit to initiate the production of audio sound and a second mode switch for sending a second input signal to the exciter control unit to initiate the clearing of water from the window panel.

19. The vehicle as set forth in claim 18, wherein the first input signal is an audio wave and the second input signal is an ultrasonic wave, and the exciter control unit is configured to receive the first and second input signals and combine the audio wave and the ultrasonic wave into the superposition wave form.

20. The vehicle as set forth in claim 16, wherein the window panel includes a windshield of the vehicle.
